(19) United States
(12) Patent Application Publication
(10) Pub. No.: US 2008/0203888 A1
(43) Pub. Date: Aug. 28, 2008

(54) Cathode Ray Tube Deflection Yoke Securing Device

(75) Inventor: Antonio Rafael Santamaria, Lancaster, PA (US)

Correspondence Address: Joseph J. Laks;Thomson Licensing LLC, 2 Independence Way, Patent Operations, PO Box 5312, PRINCETON, NJ, 08543, US

(73) Assignee: THOMSON LICENSING S.A., Boulogne-Billancourt (FR)

(21) Appl. No.: 11/793,902

(22) PCT Filed: Jan. 28, 2005
(86) PCT No.: PCT/US2005/003458

§ 371 Date: Dec. 20, 2007

Related U.S. Application Data
(60) Provisional application No. 60/640,928, filed on Dec. 31, 2004.

(51) Int. Cl. H01J 29/70; H01J 29/82

(52) U.S. Cl. 313/440; 313/482

(57) ABSTRACT

A cathode ray tube has a deflection yoke (14) secured to a glass envelope (2). The glass envelope includes a neck (4) and a funnel (5). The deflection yoke comprises an electrically insulative liner (15) provided with vertical (17) and horizontal deflection coils (19). The liner has rod receiving apertures (23) arranged proximate a rear end (20) of the liner. The rod receiving apertures extend through the liner at spaces between the vertical and horizontal deflection coils. Rods (29) are positioned in the rod receiving apertures. A clamp (30) has a locking portion (40) that engages the rods. The locking portion pushes the rods inward through the rod receiving apertures and into engagement with the neck to secure the deflection yoke to the neck of the envelope.

### CROSS-REFERENCE TO RELATED APPLICATIONS

This application claims the benefit of U.S. Provisional Patent Application Ser. No. 60/640,928, entitled “Cathode Ray Tube Deflection Yoke Securing Device” and filed Dec. 31, 2004, which is incorporated by reference herein in its entirety.

### FIELD OF THE INVENTION

The invention generally relates to a deflection yoke for a cathode ray tube and, more particularly, to a securing device for attaching a deflection yoke to a neck of a cathode ray tube.

### BACKGROUND OF THE INVENTION

A conventional deflection yoke of a cathode ray tube generally comprises vertical deflection coils and horizontal deflection coils separated by an electrically insulative liner. A ferrite member essentially in the shape of a truncated cone is positioned over top of the liner and concentrates the flux created by the horizontal and vertical deflection coils. The liner is essentially in the shape of a funnel and has a flexible end portion that extends beyond the vertical and horizontal deflection coils toward the electron gun. A locking collar or clamp is positioned on an outer annular surface of the flexible end portion of the liner. The locking collar or clamp is tightened to secure the flexible end portion of the liner to a neck of the cathode ray tube along a longitudinal axis of the cathode ray tube.

Because the overall depth of the cathode ray tube is to some degree dictated by the length of the deflection yoke, it is desirable to shorten the length of the deflection yoke to reduce the depth of the cathode ray tube. Reducing the depth of the cathode ray tube enables the cathode ray tube to remain competitive with new types of image display devices with reduced depths, such as non-cathode ray tube flat panel displays, that continue to be introduced into the marketplace.

### SUMMARY OF THE INVENTION

A cathode ray tube has a deflection yoke secured to a glass envelope. The glass envelope includes a neck and a funnel. The deflection yoke comprises an electrically insulative liner provided with vertical and horizontal deflection coils. The liner has rod receiving apertures arranged proximate a rear end of the liner. The rod receiving apertures extend through the liner at spaces between the vertical and horizontal deflection coils. Rods are positioned in the rod receiving apertures. A clamp has a locking portion that engages the rods. The locking portion pushes the rods inward through the rod receiving apertures and into engagement with the neck to secure the deflection yoke to the neck of the envelope.

### BRIEF DESCRIPTION OF THE DRAWINGS

The invention will now be described by way of example with reference to the accompanying drawings, wherein:

FIG. 1 is a cross sectional view of a cathode ray tube having a deflection yoke and a securing device according to the invention;

FIG. 2 is an exploded perspective view of the deflection yoke and the securing device; and

FIG. 3 is a plan view of the deflection yoke attached to a neck of the cathode ray tube by the securing device.

### DETAILED DESCRIPTION OF THE INVENTION

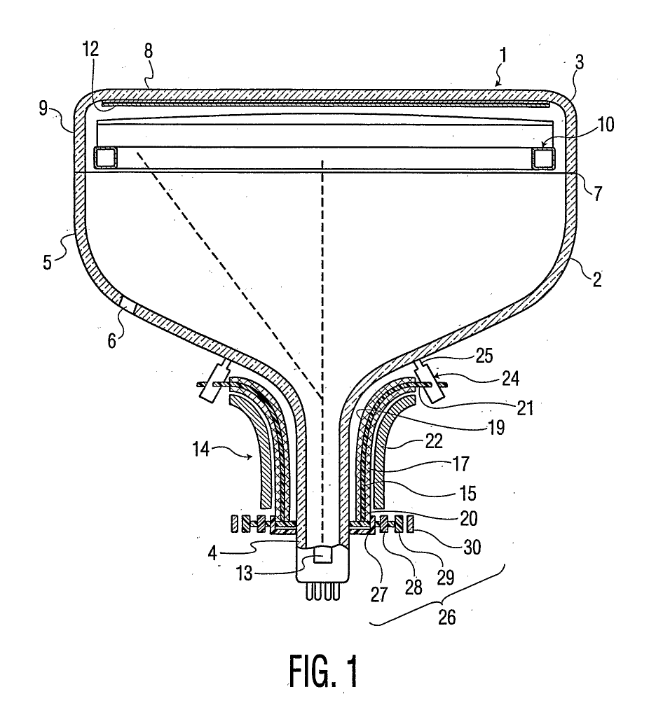

FIG. 1 shows a cathode ray tube 1 having a glass envelope 2. The glass envelope 2 includes a rectangular faceplate panel 3 and a tubular neck 4 connected by a funnel 5. The funnel 5 has an internal conductive coating (not shown) that extends from an anode button 6 toward the faceplate panel 3 and to the neck 4. The faceplate panel 3 consists of a viewing faceplate 8 and a peripheral flange or sidewall 9, which is sealed to the funnel 5 by a glass frit 7. A phosphor screen 12 is carried by an inner surface of the faceplate panel 3. The screen 12 may be, for example, a line screen with phosphor lines arranged in triads, wherein each of the triads includes three phosphor lines. A mask frame assembly 10 is removably mounted in predetermined spaced relation to the screen 12. An electron gun 13 is centrally mounted within the neck 4. The electron gun 13 can generate and direct three inline electron beams, a center beam and two side or outer beams, along convergent paths through the mask frame assembly 10 to the screen 12.

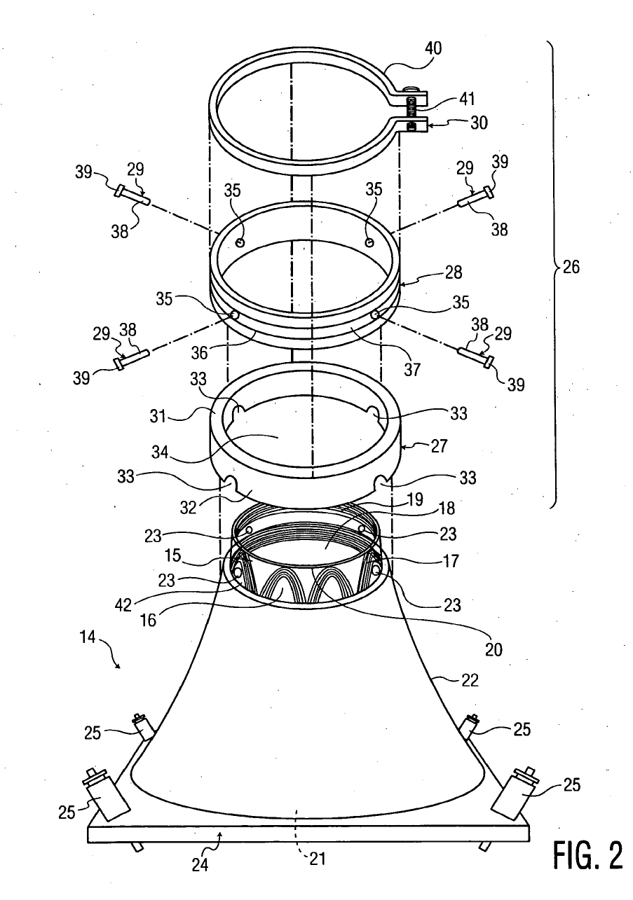

The cathode ray tube 1 is designed to be used with an external magnetic deflection yoke 14, which subjects the three beams to magnetic fields that cause the beams to scan horizontally and vertically in a rectangular raster over the screen 12. As shown in FIGS. 1 and 2, the deflection yoke 14 includes an electrically insulative liner 15 formed essentially in the shape of a funnel. As shown in FIG. 2, the liner 15 has vertical deflection coils 17 attached to an exterior surface 16 thereof, and horizontal deflection coils 19 attached to an interior surface 18 thereof. Although in the illustrated embodiment, the vertical deflection coils 17 are shown as being attached to the exterior surface 16 of the liner 15 and the horizontal deflection coils 19 are shown as being attached to the interior surface 18 of the liner 15, it will be appreciated by those skilled in the art that the horizontal deflection coils 19 may alternatively be attached to the exterior surface 16 of the liner 15 and the vertical deflection coils 17 may alternatively be attached to the interior surface 18 of the liner 15. The vertical and horizontal deflection coils 17, 19 extend from a rear end 20 of the liner 15 to proximate a front end 21 of the liner 15.

A ferrite member 22 essentially in the shape of a truncated cone is positioned over top of the exterior surface 16 of the liner 15. Rod receiving apertures 23 are formed between the ferrite member 22 and the rear end 20 of the liner 15. The rod receiving apertures 23 extend through the liner 15 from the exterior surface 16 to the interior surface 18. The rod receiving apertures 23 are arranged such that the rod receiving apertures 23 extend through the liner 15 at spaces 42 between the vertical and horizontal deflection coils 17, 19 so that the rod receiving apertures 23 do not interfere with the positioning of the vertical and horizontal deflection coils 17, 19. Although in the illustrated embodiment, two of the rod receiving apertures 23 are shown as being positioned on opposite sides of the liner 15, it will be appreciated by those skilled in the art that the rod receiving apertures 23 may be positioned in other arrangements. A funnel attachment device 24 is arranged on the front end 21 of the liner 15. The funnel attachment device 24 device has a plurality of wedges or plungers 25 for attaching the front end 21 of the liner 15 to the funnel 5, as shown in FIG. 1. Because the funnel attachment device 24 is well known in the art, it will not be described in further detail herein.

As shown in FIG. 2, the deflection yoke 14 includes a securing device 26. The securing device 26 includes a cap 27, an annular ring 28, rods 29, and a locking collar or clamp 30. The cap 27 is made from an insulative material and has a top surface 31 and an annular outer wall 32. Cut-outs 33 corresponding to the rod receiving apertures 23 are formed in the outer wall 32. The top surface 31 has a neck receiving opening 34. The annular ring 28 is made from an insulative material and has through-holes 35 corresponding to the rod receiving apertures 23 and the cut-outs 33. An annular clamp receiving groove 37 is formed on an outer surface 36 of the annular ring 28 proximate the through-holes 35. Each of the rods 29 is formed from an insulative material and includes a shaft 38 extending from a head 39. The locking collar or clamp 30 has an annular locking portion 40 and a tightening member 41. Although in the illustrated embodiment, the locking portion 40 has an annular configuration, it will be appreciated by those skilled in the art that the locking portion 40 may also be substantially C-shaped. Because the clamp 30 is well known in the art, it will not be described in further detail herein.

As shown in FIGS. 1-3, to assemble the securing device 26 to the deflection yoke 14, the cap 27 is inserted onto the rear end 20 of the liner 15. The cap 27 is positioned such that the vertical and horizontal deflection coils 17, 19 provided on the liner 15 are received inside the outer wall 32 of the cap 27, and the cut-outs 33 are aligned with the rod receiving apertures 23. The annular ring 28 is then inserted over the cap 27 such that the through-holes 35 are aligned with the cut-outs 33 and the rod receiving apertures 23. The shafts 38 of each of the rods 29 are then partially inserted into the through-holes 35 and through the cut-outs 33 and the rod receiving apertures 23. The clamp 30 is loosely positioned about the annular ring 28.

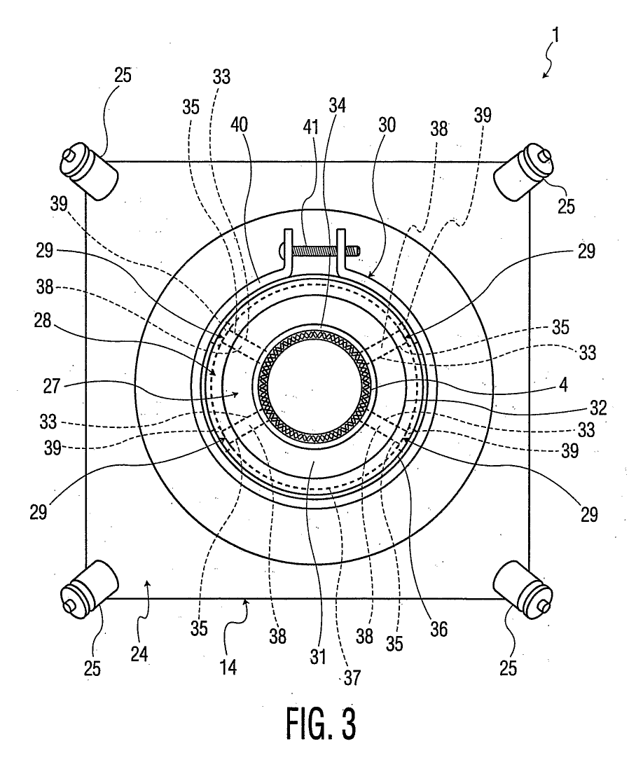

As shown in FIGS. 1 and 3, to assemble the deflection yoke 14 to the envelope 2, the neck 4 of the envelope 2 is inserted into the front end 21 of the liner 15 until the neck 4 projects from the rear end 20. Once the deflection yoke 14 has been properly aligned, the tightening member 41 of the clamp 30 is actuated to tighten the locking portion 40 about the annular ring 28. As the locking portion 40 is tightened, it presses against the heads 39 of the rods 29, and the heads 39 of the rods 29 and the locking portion 40 are received in the clamp receiving groove 37. The locking portion 40 thereby presses the shafts 38 of the rods 29 inward and into engagement with the neck 4 of the envelope 2 to secure the rear end 20 to the neck 4. The plungers 25 of the funnel attachment device 24 are then engaged with the funnel 5 of the envelope 2 to secure the front end 21 to the funnel 5. The securing device 26 thereby utilizes free space between the vertical and horizontal deflection coils 17, 19 on the liner 15 to secure the deflection yoke 14 to the envelope 2, which ultimately reduces the length of the liner. The invention has particular utility for CRTs having deflection angles exceeding 115 degrees and for CRTs having vertically oriented electron guns, wherein the phosphor stripes are horizontally oriented and the individual electron beam lines are scanned vertically.

The foregoing illustrates some of the possibilities for practicing the invention. Many other embodiments are possible within the scope and spirit of the invention. For example, in an alternate embodiment, the annular ring 28 may be eliminated from the securing device 26. In the alternate embodiment, the clamp 30 would be tightened about the cap 27 instead of the annular ring 28. Upon tightening of the clamp 30 about the cap 27, the shafts 38 of the rods 29 would be pressed inward and into engagement with the neck 4. It is, therefore, intended that the foregoing description be regarded as illustrative rather than limiting, and that the scope of the invention is given by the appended claims together with their full range of equivalents.

What is claimed is:

1. A cathode ray tube having a deflection yoke secured to a glass envelope, the glass envelope including a neck and a funnel, the deflection yoke comprising:
an electrically insulative liner provided with vertical and horizontal deflection coils, the liner having rod receiving apertures arranged proximate a rear end of the liner, the rod receiving apertures extending through the liner at spaces between the vertical and horizontal deflection coils; and
rods positioned in the rod receiving apertures, the rods being secured into engagement with the neck.

2. The cathode ray tube of claim 1, wherein a clamp having a locking portion that engages the rods, the locking portion pushing the rods inward through the rod receiving apertures and into engagement with the neck.

3. The cathode ray tube of claim 1, wherein the horizontal and vertical deflection coils extend from the rear end of the liner to proximate a front end of the liner.

4. The cathode ray tube of claim 1, wherein the deflection yoke further comprises a ferrite member positioned over top of an exterior surface of the liner, the rod receiving apertures being formed between the ferrite member and the rear end of the liner.

5. The cathode ray tube of claim 1, wherein the deflection yoke further comprises a cap positioned on the rear end of the liner, the cap having cut-outs aligned with the rod receiving apertures.

6. The cathode ray tube of claim 4, wherein the deflection yoke further comprises an annular ring positioned over an outer wall of the cap, the annular ring having through-holes aligned with the cut-outs and the rod receiving apertures.

7. The cathode ray tube of claim 5, wherein the annular ring has an annular clamp receiving groove formed on an outer surface thereof proximate the through-holes that receives the clamp.

8. The cathode ray tube of claim 1, wherein the deflection yoke further comprises a funnel attachment device arranged at a front end of the liner, the funnel attachment device having plungers engaging the funnel of the envelope.

9. The cathode ray tube of claim 1, wherein the cathode ray tube has a deflection angle exceeding 115 degrees.

10. The cathode ray tube of claim 9, wherein the cathode ray tube has vertically oriented electron guns, horizontally oriented phosphor stripes, and vertical scan lines.

11. A deflection yoke for a cathode ray tube, comprising:
an electrically insulative liner provided with vertical and horizontal deflection coils, the liner having rod receiving apertures arranged proximate a rear end of the liner, the rod receiving apertures extending through the liner at spaces between the vertical and horizontal deflection coils; and
rods positioned in the rod receiving apertures, the rods being secured into engagement with the neck.

12. The deflection yoke of claim 11, wherein a clamp having an annular locking portion that engages the rods, the locking portion pushing the rods inward through the rod receiving apertures.

13. The deflection yoke of claim 11, wherein the horizontal and vertical deflection coils extend from the rear end of the liner to proximate a front end of the liner.

14. The deflection yoke of claim 11, further comprising a ferrite member positioned over top of an exterior surface of the liner, the rod receiving apertures being formed between the ferrite member and the rear end of the liner.

15. The deflection yoke of claim 11, further comprising a cap positioned on the rear end of the liner, the cap having cut-outs aligned with the rod receiving apertures.

16. The deflection yoke of claim 15, further comprising an annular ring positioned over an outer wall of the cap, the annular ring having through-holes aligned with the cut-outs and the rod receiving apertures.

17. The deflection yoke of claim 16, wherein the annular ring has an annular clamp receiving groove formed on an outer surface thereof proximate the through-holes that receives the clamp.

18. The deflection yoke of claim 11, further comprising a funnel attachment device arranged at a front end of the liner.

19. The cathode ray tube of claim 11, wherein the cathode ray tube has a deflection angle exceeding 115 degrees.

20. The cathode ray tube of claim 11, wherein the cathode ray tube has vertically oriented electron guns, horizontally oriented phosphor stripes, and vertical scan lines.
